(19) United States
(12) Patent Application Publication
(10) Pub. No.: US 2010/0129076 A1
(43) Pub. Date: May 27, 2010

(54) METHOD AND APPARATUS FOR SPECTRAL BAND MANAGEMENT

(76) Inventor: Giovanni Barbarossa, Saratoga, CA (US)

Correspondence Address: PATTERSON & SHERIDAN, LLP, 3040 POST OAK BLVD, SUITE 1500, HOUSTON, TX, 77056, US

(21) Appl. No.: 12/277,115

(22) Filed: Nov. 24, 2008

(51) Int. Cl. H04J 14/00

(52) U.S. Cl. 398/48; 398/45

(57) ABSTRACT

Optical signal bands having different bandwidths are selectively directed along different optical paths. Some optical signal bands are directed along more than one optical path. Also, a group of optical signal bands having different bandwidths may be directed along a selected optical path.

### BACKGROUND OF THE INVENTION

1. Field of the Invention

Embodiments of the present invention relate generally to optical communication systems and components and, more particularly, to a method and apparatus for spectral band management.

2. Description of the Related Art

In a wavelength division multiplexing (WDM) optical communication system, information is carried by multiple channels, each channel having a unique wavelength. WDM allows transmission of data from different sources over the same fiber optic link simultaneously, since each data source is assigned a dedicated channel. The result is an optical communication link with an information-carrying capacity that increases with the number of wavelengths, or channels, incorporated into the WDM signal. In this way, WDM technology maximizes the use of an available fiber optic infrastructure; what would normally require multiple optic links or fibers instead requires only one.

As the demand for optical communication networks increases, it is desirable to increase transport efficiency of an optical fiber, i.e., the amount of information carried by the optical fiber. This can be accomplished by increasing the number of channels in a WDM signal carried by a fiber and/or by increasing the data signaling rate, i.e., the bit rate, of the WDM signal.

Channel spacing is the amount of bandwidth allotted to each channel in a WDM communications system, and is defined as the spacing between center wavelengths of adjacent optical channels. To increase the number of channels in a WDM signal, the channel spacing is decreased. For example, a fiber may carry a WDM signal with a channel spacing of 100 GHz and consisting of 10 wavelength channels. When the channel spacing of the WDM signal is reduced to 50 GHz, the same fiber may instead carry 20 channels. Thus, when transmitting an optical signal using a modulation format with higher spectral efficiency, a narrower bandwidth is required for each channel, and the channel spacing for a WDM signal can be decreased.

Different modulation formats for digital modulation of an optical carrier signal include return to zero (RZ), non-return to zero (NRZ), dual binary (DB), differential phase-shift keying (DPSK), quadrature phase-shift keying (QPSK), and binary phase-shift keying (BPSK), among others. For an optical carrier signal having a given bit rate, each modulation format can produce a different modulation bandwidth, where “modulation bandwidth” is defined as the peak width of a modulated signal at 50% of the peak height, i.e., full-width at half-maximum (FWHM). For example, a 10 Gigabit per second (Gpbs) DB signal occupies approximately one third as much bandwidth as a 10 Gbps signal that is formatted in NRZ, and, consequently, the modulation bandwidth of the 10 Gbps DB signal is approximately one third the bandwidth of the 10 Gbps NRZ signal.

Increasing the bit rate of a WDM signal can also improve the transport efficiency of a signal, since more data is transmitted over the same fiber per unit time. However, it is known that the modulation bandwidth of a modulated signal increases with bit rate. Thus, when the bit rate of a WDM signal is increased, the modulation bandwidth of each channel in the WDM signal broadens, which can require a wider channel spacing to ensure adequate isolation between adjacent channels.

In sum, the information-carrying capacity of an optical communications network can be improved without replacing or increasing the number of fibers in the optical communications network by decreasing channel spacing, increasing the bit rate, and/or changing the modulation format of in a WDM signal.

However, to convert an existing optical communications network to process WDM signals having a narrower channel spacing, a higher bit rate, and/or a different modulation format, a number of network components must be replaced, including lasers, wavelength lockers, and optical switches, among others. To avoid obsoleting existing optical network components that may still have significant useful service life, and to minimize the network downtime associated with such an overhaul, the network can instead be modified to transmit multiple heterogeneous optical signals. Thus, existing network hardware can transmit and receive channels in a WDM signal at one bit rate and modulation format, while newly installed network hardware can be selected to take advantage of higher speeds and/or different modulation formats, as described below.

FIG. 1A illustrates a schematic representation of the available transmission spectrum 104 of an optical fiber used in an optical communication network. A graph is superimposed on available transmission spectrum 104 depicting the light intensity (I) distribution of a demultiplexed optical carrier signal 100 vs. horizontal position (X), where the optical carrier signal 100 includes a plurality of transmission bands 101. The horizontal position of each band corresponds to a specific segment of available transmission spectrum 104, and each of transmission bands 101 is populated by a wavelength channel 109. Wavelength channels 109 each have substantially the same modulation bandwidth 102, and transmission bands 101 are distributed on a uniform wavelength grid 105, i.e., each of transmission bands 101 is separated from adjacent ands by channel spacing 103, e.g., 50 GHz. Channel spacing 103 is selected to be larger than modulation bandwidth 102 to ensure that each of wavelength channels 109 is adequately isolated from each adjacent wavelength channel after demultiplexing. As shown, transmission bands 101 of optical carrier signal 100 do not occupy the entire available transmission spectrum 104 allocated for optical carrier signal 100, leaving a region of excess capacity 108 of available transmission spectrum 104. Thus optical carrier signal 100 can be expanded to include additional channels, as illustrated in FIG. 1B.

FIG. 1B illustrates a schematic representation of the light intensity distribution of an optical carrier signal 110 vs. horizontal position after being demultiplexed. Optical carrier signal 110 includes the plurality of transmission bands 101 from optical carrier signal 100 as well as additional bands 111A, 111B. To utilize excess capacity 108 of available transmission spectrum 104, additional bands 111A, 111B are positioned on uniform wavelength grid 105 in the region of excess capacity 108. As part of optical carrier signal 110, additional channels 119A, 119B populate additional bands 111A, 111B as shown, and are transmitted and received over the same optical fiber as wavelength channels 109, using components that have been added to the original optical network. For example, an optical network can be enhanced with additional nodes that transmit and receive additional channels 111A, 111B. Therefore, instead of installing an additional fiber ring for carrying the traffic contained in additional channels 119A, 119B, available transmission spectrum 104 of the original fiber is utilized.

Additional channels 119A, 119B transmit information at a higher bit rate than wavelength channels 109 and, thus, have a modulation bandwidth 112 that is wider than modulation bandwidth 102 of wavelength channels 109. For example, wavelength channels 109 are 10 GHz DPSK signals and additional channels 119A, 119B are 40 GHz DPSK signals, while channel spacing 103 is 50 GHz. As shown in FIG. 1B, channel spacing 103 is too narrow to accommodate additional channels 119A, 119B, thereby resulting in overlap therebetween. Such interference between wavelength channels is highly undesirable in an optical network, and a wider channel spacing is needed for optical carrier signal 110 to function properly.

FIG. 1C illustrates a schematic representation of the light intensity distribution of an optical carrier signal 120 vs. horizontal position after being demultiplexed. Optical carrier signal 120 includes wavelength channels 109 and additional channels 119A, 119B from optical carrier signal 110. In optical carrier signal 120, wavelength channels 109 and additional channels 119A, 119B are each contained in one of widened bands 130. As shown, widened bands 130 are distributed on a uniform wavelength grid 125, which has a wider channel spacing 123 than channel spacing 103 of uniform wavelength grid 105 in FIGS. 1A, 1B. Wider channel spacing 123 prevents interference between additional channels 119A, 119B. With wider channel spacing 123 of widened bands 130, wavelength channels having a wider modulation bandwidth than wavelength channels 109 can be carried by optical carrier signal 120. Therefore, additional channels 119A, 119B can be included in optical carrier signal 120 to utilize excess capacity in an optical fiber, such as excess capacity 108 in FIG. 1A, and additional channels 119A, 119B can include wavelength channels having a higher bit rate and/or a different modulation format than wavelength channels 109.

However, in order to uniformly distribute bands 101 and additional bands 111A, 111B on uniform wavelength grid 125 so that channels having different modulation bandwidths can be included in a single optical carrier signal, other portions of available transmission spectrum 104 are not efficiently used. Because modulation bandwidth 102 of wavelength channels 109 is substantially narrower than wider channel spacing 123, widened bands 130 are larger than necessary to accommodate transmission of wavelength channels 109. Consequently, bandwidth segments 129, which are disposed between wavelength channels 101, remain idle and are not utilized for transmitting optical signals. Thus, an optical network as known in the art can be configured with bands accommodating a heterogeneous collection of wavelength channels, i.e., a plurality of wavelength channels having different modulation bandwidths, but only in a manner that does not efficiently utilize all portions of the usable bandwidth of an optical fiber.

Accordingly, there is a need in the art for a method and apparatus for efficiently utilizing the available transmission bandwidth of an optical fiber when the fiber is used to carry wavelength channels having different modulation bandwidths.

### SUMMARY OF THE INVENTION

Embodiments of the invention contemplate a method and apparatus for selectively switching bands in an optical carrier signal. A method for routing an optical signal, according to a first embodiment, comprises receiving an optical signal having a plurality of bands distributed over a transmission spectrum, directing a first band having a first width along a first optical path, and directing a second band having a second width along a second optical path, wherein the first width and the second width are different. A method for routing an optical signal, according to second embodiment, comprises receiving an optical signal having a plurality of transmission bands of different bandwidths distributed over a transmission spectrum and directing a group of the bands along a selected optical path, wherein widths of at least two bands in the group are different.

An optical device, according to an embodiment of the invention, comprises an input port for receiving an optical signal having a plurality of bands of different widths distributed over a transmission spectrum and a switch assembly configured to direct a first group of bands along a first optical path and a second group of transmission bands along a second optical path. The number of bands in the two groups may be different and the widths of the bands in the two groups may be different.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1C illustrate schematic representations of the light intensity distribution of a demultiplexed optical carrier signals vs. horizontal position.

FIG. 2A illustrates a schematic representation of the available transmission bandwidth of an optical fiber used in an optical communication network, according to an embodiment of the invention.

FIG. 2B schematically illustrates the available transmission bandwidth of an optical fiber with a graph of the light intensity distribution of an optical carrier signal superimposed thereon, according to an embodiment of the invention.

FIG. 2C schematically illustrates two resultant optical signals that are produced by selectively directing portions of an optical carrier signal along different optical paths, according to an embodiment of the invention.

FIG. 2D schematically illustrates two resultant optical signals that are produced by selectively directing portions of an optical carrier signal along two different optical paths while broadcasting other portions of the optical carrier signal along both optical paths, according to an embodiment of the invention.

FIG. 3 schematically illustrates an optical network configured to transmit an optical carrier signal having a non-uniform wavelength grid, according to an embodiment of the invention.

FIG. 4 schematically illustrates a cross sectional view of an LC-based optical switch which may be incorporated into an optical switching device, according to an embodiment of the invention.

FIGS. 5A and 5B schematically illustrate top plan and side views, respectively, of an LC-based optical switching device, in accordance with one embodiment of the invention.

FIG. 5C schematically illustrates a cross-sectional view of an LC array taken at section line a-a, as indicated in FIG. 5A.

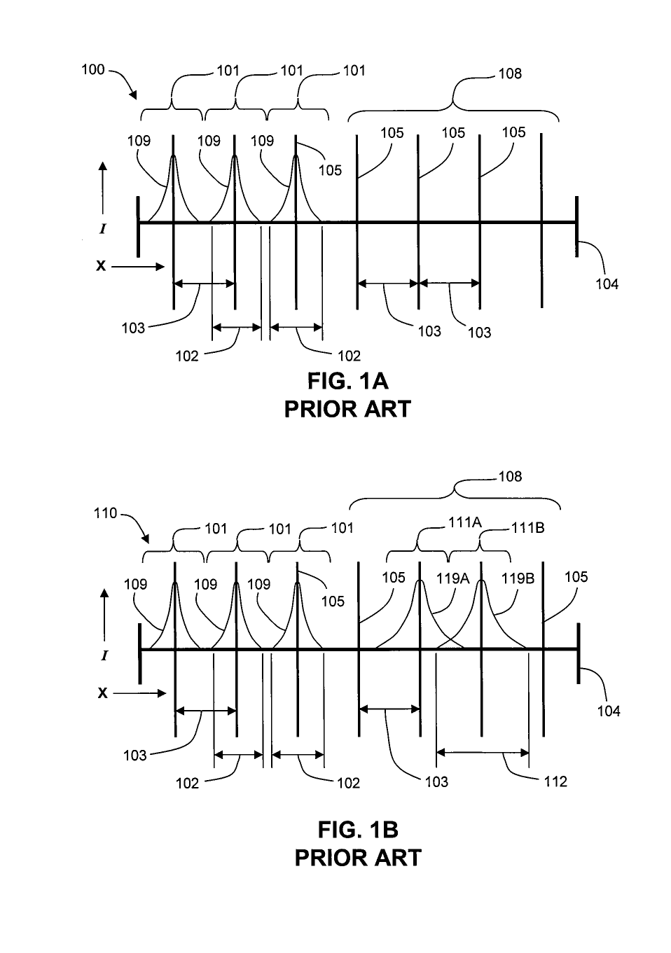

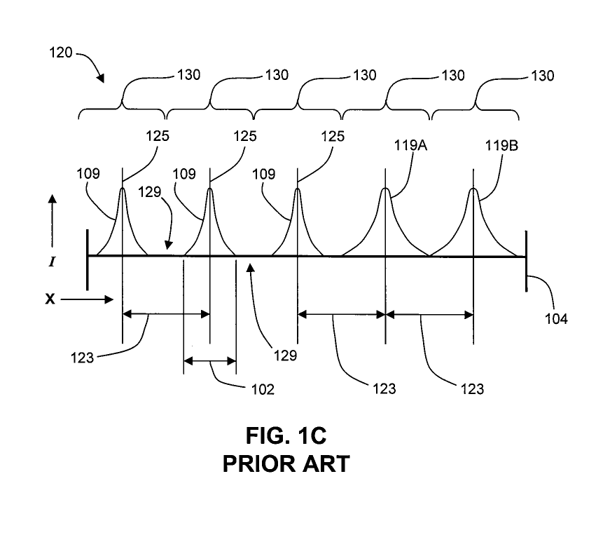

For clarity, identical reference numbers have been used, where applicable, to designate identical elements that are common between figures. It is contemplated that features of one embodiment may be incorporated in other embodiments without further recitation.

### DETAILED DESCRIPTION

Embodiments of the invention contemplate a method and apparatus for selectively switching bands in an optical carrier signal. When an optical carrier signal is demultiplexed, the bands that make up the available transmission bandwidth of an optical fiber may be of non-uniform bandwidth and arranged on a non-uniform wavelength grid so that portions of the optical fiber bandwidth are not left unused. An optical switching device, according to an embodiment of the invention, is used to arrange the wavelength grid for the demultiplexed optical carrier signal based on the bandwidth of each band, where each band may be populated by one or more wavelength channels. In one embodiment, the optical switching device includes a plurality of independently controllable pixel elements, or subpixels, that can be combined as necessary to form macropixels of the appropriate geometry to optically switch each band as desired, regardless of the bandwidth of each band or modulation bandwidth of the wavelength channels populating each band.

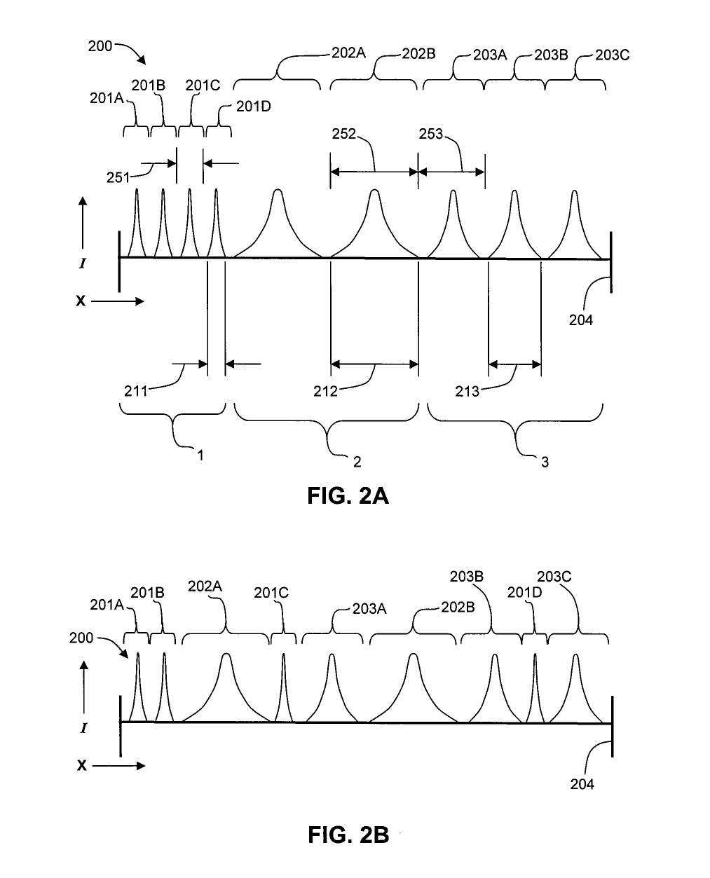

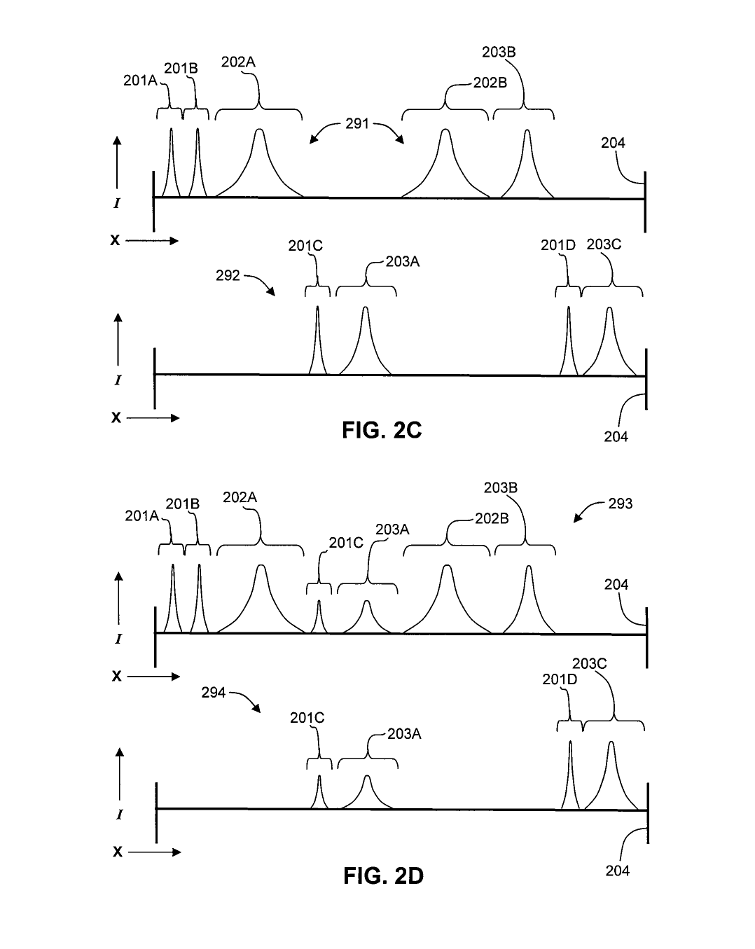

FIG. 2A illustrates a schematic representation of the available transmission spectrum 204 of an optical fiber used in an optical communication network. A graph is superimposed on available transmission spectrum 204 depicting the light intensity (I) distribution of a demultiplexed optical carrier signal 200 vs. horizontal position (X), where the optical carrier signal 200 includes a plurality of bands 201A-D, 202A-B, and 203A-C, where the horizontal position of each band corresponds to a specific segment of available transmission spectrum 204. For purposes of illustration, each of bands 201A-D, 202A-B, and 203A-C is depicted containing a wavelength channel. However, embodiments of the invention also contemplate an optical carrier signal with one or more bands being populated with no wavelength channel or multiple wavelength channels.

Because optical carrier signal 200 is demultiplexed, the bands contained therein, i.e., bands 201A-D, 202A-B, and 203A-C, are spatially dispersed. As shown, bands 201A-D are each populated with a wavelength channel having a relatively narrow modulation bandwidth 211. Bands 201A-D are positioned in region 1 of available transmission spectrum 204 with a correspondingly narrow channel spacing 251. Similarly, bands 202A-B are each populated with wavelength channels having a relatively wide modulation bandwidth 212. Bands 202A-B are positioned in region 2 of available transmission spectrum 204 with a correspondingly wide channel spacing 252. Bands 203A-C are each populated with a wavelength channel having a modulation bandwidth 213, and are positioned in region 3 of available transmission spectrum 204 with an appropriately sized channel spacing 253.

The differences between modulation bandwidths 211, 212, and 213 may be due to the different bit rates and/or modulation formats of the wavelength channels populating bands 201A-D, 202A-B, and 203A-C. For example, the wavelength channels contained in bands 202A-B may be 40 Gbps DPSK signals while the wavelength channels contained in bands 203A-C may be 10 Gbps DPSK signals, which have a substantially narrower modulation bandwidth. Alternatively, the wavelength channels populating bands 201A-D may be transmitted in one modulation format, e.g., DB, and the wavelength channels populating bands 202A-B may be transmitted in another modulation format, e.g., NRZ, while the wavelength channels contained in bands 203A-C may be transmitted in a third modulation format, e.g., DPSK. One of skill in the art will appreciate that available transmission spectrum 204 is not made up of bands distributed across on a uniform wavelength grid, as is commonly known in the art. Rather, bands 201A-D, 202A-B, and 203A-C, have different bandwidths as required, so that available transmission spectrum 204 is utilized most efficiently.

According to one embodiment of the invention, it is contemplated that bands 201A-D, 202A-B, and 203A-C contained in optical carrier signal 200 may be arranged in a more general fashion, as illustrated in FIG. 2B. FIG. 2B schematically illustrates available transmission spectrum 204 with a graph of the light intensity distribution of optical carrier signal 200 superimposed thereon, where the optical carrier signal 200 includes a plurality of bands 201A-D, 202A-B, and 203A-C arranged in an arbitrary fashion. As shown, bands having similar bandwidth, such as bands 202A-B, are not necessarily grouped together, and the wavelength grid on which bands 201A-D, 202A-B, and 203A-C are arranged may be highly non-uniform, so that available transmission spectrum 204 is efficiently utilized.

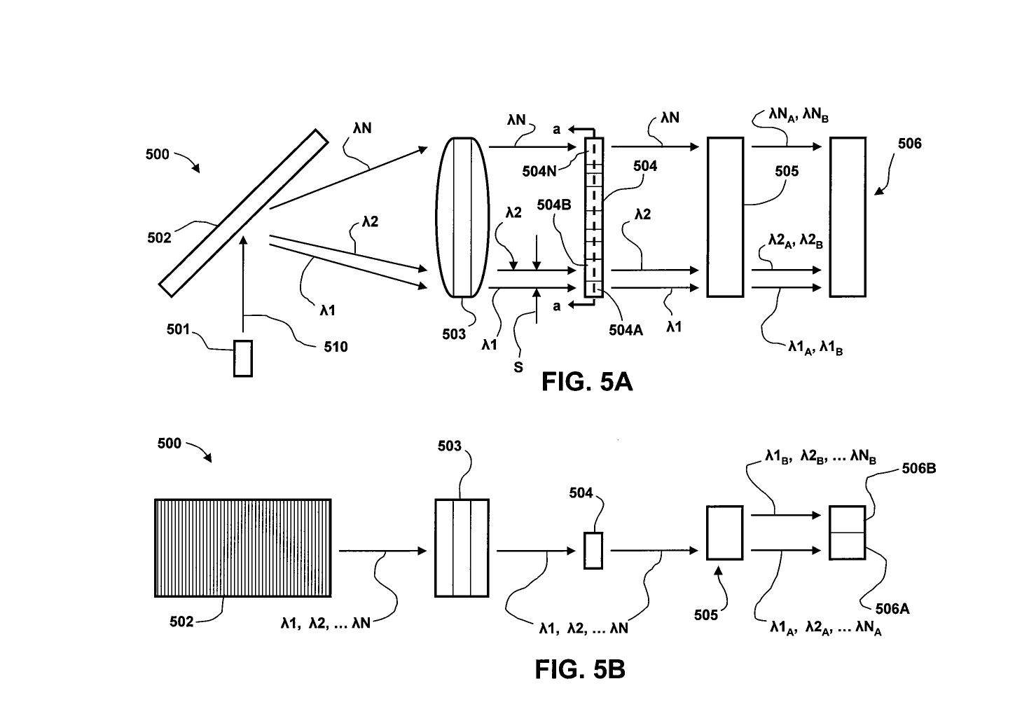

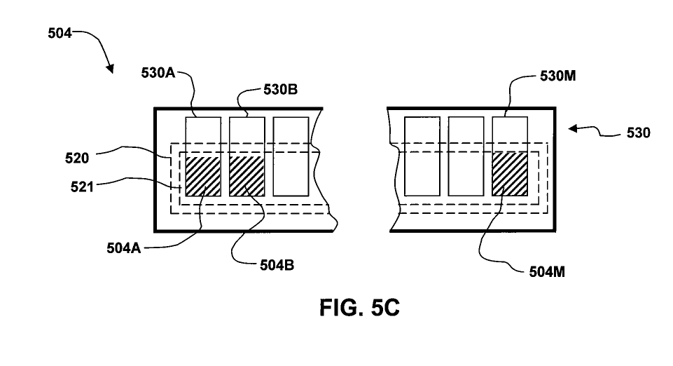

FIG. 2C schematically illustrates two resultant optical signals 291, 292 that are produced by selectively directing portions of optical carrier signal 200 along different optical paths, according to an embodiment of the invention. Resultant optical signal 291 includes a plurality of bands from optical carrier signal 200, i.e., bands 201A-B, 202A-B, and 203B. Resultant optical signal 292 includes the remainder of bands from optical carrier signal 200, i.e., bands 201C-D, 203A, and 203C. Resultant optical signals 291, 292 are selectively directed along different optical paths when optical carrier signal 200 is directed to an optical switching device, such as optical switching devices 341, 342, described below in conjunction with FIGS. 5A-C. As shown, the bands contained in either resultant optical signal 291 or 292 are not limited to a single bandwidth. In addition, said bands are not limited to a specific location in available transmission spectrum 204, i.e., the bands contained in either resultant optical signal 291 or 292 need not be selected from a single contiguous portion of available transmission spectrum 204. Further, each band contained in resultant optical signals 291, 292 may be populated by one or more wavelength channels. Resultant optical signal 291 may include bands that are populated with one or more wavelength channels to be routed to a different destination node than wavelength channels populating resultant optical signal 292. Alternatively, resultant optical signal 291 may include bands populated by “dropped” wavelength channels, in which case resultant optical signal 291 is directed to a light dump.

FIG. 2D schematically illustrates two resultant optical signals 293, 294 that are produced by selectively directing portions of optical carrier signal 200 along two different optical paths while broadcasting other portions of optical carrier signal 200 along both optical paths, according to an embodiment of the invention. Resultant optical signals 293, 294 are similar to resultant optical signals 291, 292, in FIG. 2C, except that a portion of the optical energy contained in bands 201C and 203A is directed along each optical path. Thus, each of resultant optical signals 293, 294 includes bands 201C and 203A. As depicted in FIG. 2D, when bands 201C and 203A are broadcast along two optical paths, the intensity of wavelength channels populating bands 201C and 203A is reduced by approximately half, but can subsequently be amplified by means well known in the art.

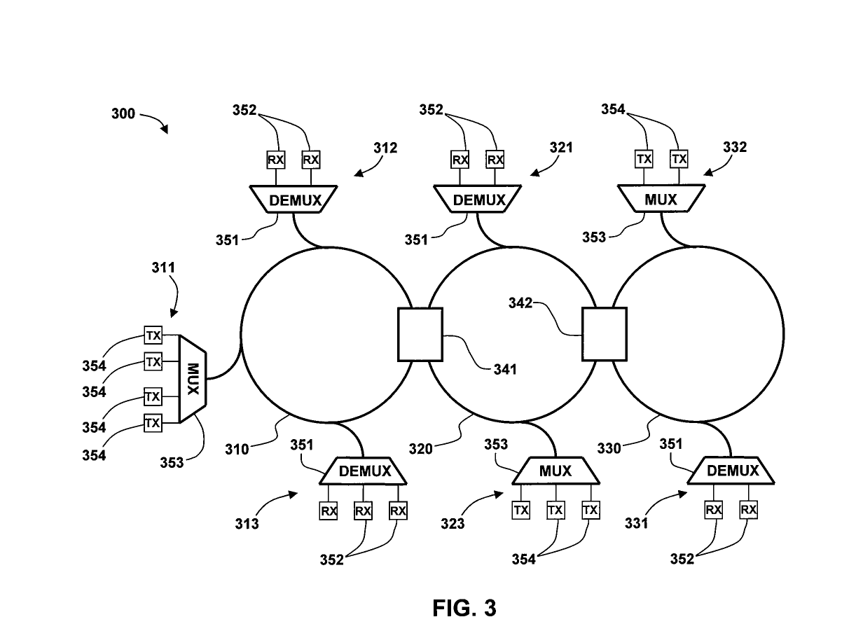

FIG. 3 schematically illustrates an optical network 300 configured to transmit optical carrier signal 200 having a non-uniform wavelength grid, according to an embodiment of the invention. Optical network 300 includes optical rings 310, 320, and 330, which are optically linked via optical switching devices 341, 342, as shown. Optical ring 310 includes transmitting node 311 and receiving nodes 312 and 313. Optical ring 320 includes receiving node 321 and transmitting node 323. Optical ring 330 includes receiving node 331 and transmitting node 332. It is understood that optical components of optical communication networks are typically bidirectional in nature, and therefore may distribute optical signals in both directions, i.e., from a transmitting node, e.g., transmitting node 311, to a receiving node, e.g., receiving node 331, and vice-versa. For clarity, the operation of optical network 300 is described using unidirectional optical paths from the transmitting nodes to the receiving nodes.

Receiving nodes 312, 313, 321, and 331 each include an optical demultiplexer 351 and one or more optical receivers 352, as shown in FIG. 3, where each receiving node is configured with one optical receiver 352 for each optical wavelength channel to be received at that node. For example, receiving node 313 is configured to receive three bands and includes an optical demultiplexer 351 and three optical receivers 352. Similarly, transmitting nodes 311, 323, and 332 each include an optical multiplexer 353 and one or more optical transmitters 354, one optical transmitter 354 for each bands to be transmitted from each respective node.

The transmitting and receiving nodes of optical network 300 are each configured to transmit or receive wavelength channels that each have a fixed optical wavelength and modulation format and are positioned in a band of available transmission spectrum 204. However, because optical network 300 is configured with optical switching devices 341, 342, the bands containing the wavelength channels that make up the optical carrier signal transmitted over optical network 300 do not have to be arranged along a uniform wavelength grid. Consequently, each transmitting node of optical network 300 may transmit wavelength channels via bands of different bandwidth. Thus, wavelength channels having different modulation formats and/or bit rates can be arranged to efficiently utilize available transmission spectrum 204. For example, transmitting node 311 may be configured to transmit the wavelength channels populating bands 201A-D, transmission node 332 may be configured to transmit the wavelength channels populating bands 202A-B in FIG. 2B, and transmission node 323 may be configured to transmit the wavelength channels populating bands 203A-C in FIG. 2B. As described above in conjunction with FIGS. 2A and 2B, the bandwidth of bands 201A-D may be different than the bandwidth of bands 202A-B and of bands 203A-C. Thus, each of optical transmitters 354 may be configured to transmit one wavelength channel having a unique center frequency and modulation bandwidth, where each channel is contained in a band of optical carrier signal 200 having the necessary bandwidth. One of skill in the art will appreciate that the configuration of each optical transmitter 354 in optical network 300 may be selected so that optical carrier signal 200 is divided into bands arranged to efficiently utilize the available transmission spectrum 204 of optical carrier signal 200. As noted above, FIGS. 2A and 2B illustrate two such arrangements of bands 201A-D, 202A-B, and 203A-C.

Similarly, each receiving node of optical network 300 may be configured to receive wavelength channels positioned in bands of available transmission spectrum 204 having different bandwidth than the bands configured for other receiving nodes in optical network 300. For example, receiving node 321 may be configured to receive wavelength channels positioned in bands 201A-B, receiving node 331 may be configured to receive wavelength channels positioned in bands 201C-D, receiving node 312 may be configured to receive wavelength channels positioned in bands 202A-B, and receiving node 313 may be configured to receive wavelength channels positioned in bands 203A-C.

In operation, at each transmission node in optical network 300, e.g., transmitting node 311, one or more wavelength channels are transmitted and multiplexed into an optical carrier signal that is circulated over a corresponding optical ring, e.g., optical ring 310. Optical switching devices 341, 342 receive circulated optical carrier signals as input signals, demultiplex each input signal into individual wavelength channels, sort the wavelength channels based on destination, and multiplex and transmit the sorted wavelength channels along the appropriate optical ring.

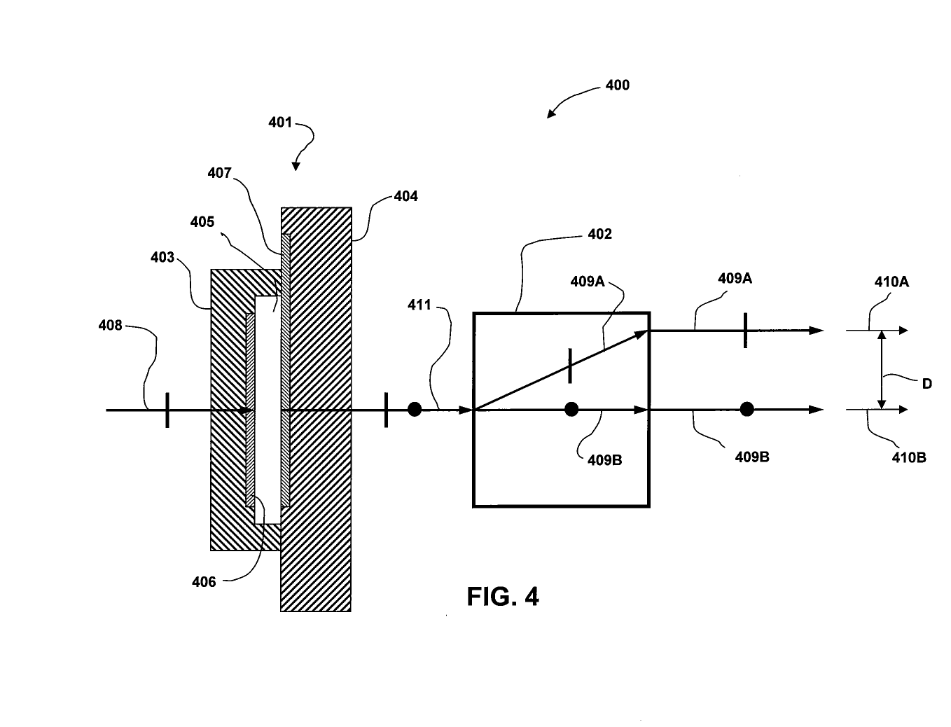

Optical switching devices 341, 342 are configured to sort bands of available transmission spectrum 204 that are arranged on a non-uniform wavelength grid, the advantages of optical network 300 over prior art optical networks are threefold. First, wavelength channels having different modulation bandwidths may be transmitted over optical network 300 simultaneously without the need for broadening the wavelength grid to accommodate channels with a wide modulation bandwidth. This allows transmitting and receiving nodes to be added to optical network 300 to efficiently take advantage of available transmission bandwidth, where the added nodes can operate at state-of-the-art bit rates and/or modulation formats. Thus existing node components can be left in place and wavelength channels operating at slower bit rates and/or different modulation formats can be used simultaneously with newly added wavelength channels. Second, by efficiently utilizing the available transmission bandwidth of an existing optical ring, the need for additional fiber rings to be installed may be avoided. Third, some embodiments of an optical switching device, such as those described below in conjunction with FIGS. 4 and 5A-5C, can be reconfigured “on-the-fly.” That is, as network architecture is dynamically modified, for example one or more nodes are added, removed, or reconfigured to transmit and receive different wavelength channels, an optical network configured with optical switching devices as described herein may be dynamically reconfigured. In this way, wavelength channels of any desired modulation bandwidth can be managed and routed with no interruption to network operation due to mechanical modification or replacement of components in optical switching devices 341, 342. This is because the optical beam deflector subpixels that make up the macropixels of an optical switching device can be aggregated into a new configuration using software only. Optical beam deflector subpixels and macropixels contained in one embodiment of an optical switching device are described below in conjunction with FIGS. 4 and 5A-C.

In one embodiment, optical switching devices 341, 342 are similar in operation and organization to wavelength selective switches known in the art, and, thus, route light populating each band making up an optical carrier signal, i.e., the individual wavelength channels, from one node in an optical network to another node. For example, optical switching device 341 can demultiplex a wavelength channel transmitted from transmitting node 311 over optical ring 310, and route the wavelength channel to optical ring 320 for receipt by the appropriate receiving node. In addition, optical switching devices 341, 342 route the wavelength channels in an optical carrier signal when the wavelength channels populate bands that are arranged along a non-uniform wavelength grid, as illustrated in FIGS. 2A, 2B. To that end, optical switching devices 341, 342 are configured with an array of optical beam deflectors having a plurality of independently controllable pixel elements, or subpixels. The subpixels can be combined to form macropixels having the necessary geometry to direct demultiplexed bands of any desired bandwidth. Thus optical switching devices 341, 342 have configurable channel spacings that are not defined by a uniform wavelength grid and instead may be defined by the modulation bandwidth of each wavelength channel routed through optical switching devices 341, 342.

Optical beam deflectors suitable for use as subpixels in optical switching devices 341, 342 include liquid crystals (LCs), microelectromechanical system (MEMS) micromirrors, and any other optical switching devices that can be miniaturized to the extent necessary to allow organization in a subpixel array, such as electro-optic and magneto-optic switches. By way of illustration, an LC-based optical switching device is described herein that can be incorporated into optical network 300 as illustrated in FIG. 3. While the LC-based optical switching device described herein uses liquid crystal polarization modulators in conjunction with a beam steering device to serve as optical beam deflectors, one skilled in the art will appreciate that reflective LC devices may also be used as optical beam deflectors.

FIG. 4 schematically illustrates a cross sectional view of an LC-based optical switch which may be incorporated into an optical switching device, e.g., optical switching device 341 or 342, according to an embodiment of the invention. An LC optical switch 400, as described herein, may serve as an optical beam deflector subpixel, and includes an LC assembly 401 and a beam steering unit 402. In the example shown, LC assembly 401 includes two transparent plates 403, 404, which are laminated together to form LC cavity 405. LC cavity 405 contains an LC material that modulates, i.e., rotates, the polarization of an incident beam of linearly polarized light as a function of the potential difference applied across LC cavity 405. LC assembly 401 also includes two transparent electrodes 406, 407, which are configured to apply the potential difference across LC cavity 405, thereby aligning the LCs in LC assembly 401 to be oriented in a first direction, a second direction or somewhere between these two directions. In this way, LC assembly 401 may modulate the polarization of incident light as desired between the s- and p-polarized states. Transparent electrodes 406, 407 may be patterned from indium-tin oxide (ITO) layers, as well as other transparent conductive materials. Beam steering unit 402 may be a birefringent beam displacer, such as a YV0₄ cube, or a Wollaston prism. Beam steering unit 402 is oriented to separate a linearly polarized beam 411 directed from LC assembly 401 into two polarized beams 409A, 409B, wherein each has a polarization state orthogonal to the other, i.e., p- and s-polarized. In the example shown in FIG. 4, polarized beam 409A is p-polarized (denoted by the vertical line through the arrow representing polarized beam 409A), and polarized beam 409B is s-polarized (denoted by a dot).

In operation, LC optical switch 400 conditions a linearly polarized input beam 408 to form one or two polarized beams 409A, 409B, as shown in FIG. 4. LC optical switch 400 then directs polarized beam 409A along optical path 410A and polarized beam 409B along optical path 410B. For a switching operation, in which a beam is routed along one of two optical paths, LC optical switch 400 converts all of the optical energy of input beam 408 to either polarized beam 409A or 409B. For an attenuating operation, LC optical switch 400 converts a portion of the optical energy of input beam 408 into polarized beam 409A and a portion into polarized beam 409B, as required, where polarized beam 409B is then directed to a light sink. For a broadcasting operation, LC optical switch 400 converts substantially equal portions of input beam 408 into polarized beam 409A and polarized beam 409B.

In the example illustrated in FIG. 4, input beam 408 is a beam of p-polarized light, denoted by a vertical line through the arrow representing input beam 408. Input beam 408 passes through LC assembly 401 and is directed through the LC contained in LC cavity 405 to produce linearly polarized beam 411. When input beam 408 passes through LC cavity 405, the polarization state of the beam may be rotated 90°, left unchanged, i.e., rotated 0°, or modulated somewhere in between, depending on the molecular orientation of the LC material contained in LC cavity 405. Therefore, linearly polarized beam 411 may contain an s-polarized component and a p-polarized component. Beam steering unit 402 produces polarized beam 409A from the p-polarized component of linearly polarized beam 411, and polarized beam 409B from the s-polarized component of linearly polarized beam 411, as shown in FIG. 4. Beam steering unit 402 is oriented to direct polarized beam 409A along optical path 410A and polarized beam 409B along optical path 410B, where optical paths 410A, 410B are parallel optical paths separated by a displacement D. The magnitude of displacement D is determined by the geometry and orientation of beam steering unit 402.

FIGS. 5A and 5B schematically illustrate top plan and side views, respectively, of an LC-based optical switching device, in accordance with one embodiment of the invention. In the example illustrated in FIGS. 5A and 5B, optical switching device 500 includes an optical input port 501, a diffraction grating 502, a lens 503, an LC array 504, a beam steering device 505, and an output/loss port assembly 506.

A WDM input signal, beam 510, is optically coupled to diffraction grating 502 by optical input port 501. Diffraction grating 502 demultiplexes beam 510 into a plurality of N wavelength channels λ1-λN, wherein each of wavelength channels λ1-λN is spatially separated from the other channels along a unique optical path, as shown in FIG. 5A. In the example shown, the unique optical paths followed by wavelength channels λ1-λN are positioned in the same horizontal plane. Wavelength channels λ1-λN are optically coupled to LC array 504 by lens 503, and each may have a unique channel spacing associated therewith. The spatial separation S between each wavelength channel is proportional to the channel spacing between each of wavelength channels λ1-λN. For example, the spatial separation S between two demultiplexed wavelength channels with a 100 GHz channel spacing is twice that for a 50 GHz channel spacing. As described above in conjunction with FIGS. 2A, 2B, the channel spacing, and therefore the spatial separation S, between any two wavelength channels may be non-uniform when projected onto LC array 504.

LC array 504 contains a plurality of LC macropixels 504A-504N, each of which is positioned to correspond to one of wavelength channels λ1-λN. Each LC macropixel 504A-504N of LC array 504 contains one or more LC subpixels that may be substantially similar in configuration and operation to LC assembly 401 in FIG. 4, where each of the subpixels is independently controlled, but can be aggregated with adjacent subpixels to function as a single macropixel. The organization of the LC subpixels and LC macropixels 504A-504N in LC array 504 is described below in conjunction with FIG. 5C. As wavelength channels λ1-λN pass through LC array 504, the polarity of each wavelength channel is conditioned by the associated macropixel as desired. As described above in conjunction with FIG. 4, for a switching operation, the corresponding LC macropixel of LC array 504 converts all of the optical energy of the wavelength channel to either s-polarized or p-polarized. For an attenuating operation, the corresponding LC macropixel converts a portion of a wavelength channel to s-polarized and a portion to p-polarized, as required. Hence each wavelength channel, or a portion thereof, that is to be routed to output port 506A is conditioned with a first polarization state, and each wavelength channel, or portion thereof, that is to be routed to output port 506B is conditioned with a second polarization state that is orthogonal to the first. For example, wavelength channels bound for output port 506A may be p-polarized and wavelength channels bound for output port 506B may be s-polarized, or vice-versa.

After conditioning by LC array 504, wavelength channels λ1-λN pass through beam steering device 505, which is substantially similar to beam steering unit 402 of FIG. 4. Therefore, depending on the polarization state of each wavelength channel, beam steering device 505 steers each wavelength channel along an upper optical path, a lower optical path, or a portion along both, as depicted in FIG. 5B. In this way, beam steering device 505 directs s-polarized beams to one output port and p-polarized beams to the other output port, i.e., wavelength channels λ1_{A}-λN_{A} are directed to output port 506A and wavelength channels λ1_{B}-λN_{B} are directed to output port 506B. It is noted that when optical switching device 500 performs an attenuation operation on wavelength channels λ1-λN, one of the output ports 506A, 506B may act as a loss port and the other as a conventional output port.

FIG. 5C schematically illustrates a cross-sectional view of LC array 504 taken at section line a-a, as indicated in FIG. 5A. LC array 504 includes an LC cavity 520 containing an LC material, a common horizontal electrode 521, and an array 530 of vertical electrodes 530A-530M, where M equals the number of LC subpixels in LC array 504. Common horizontal electrode 521 is positioned behind LC cavity 520, and may be substantially similar in make-up to transparent electrode 406, described above in conjunction with FIG. 4. In the example shown in FIG. 5B, common horizontal electrode 521 serves as an electrode for all LC subpixels 504A-504M (shaded regions) of LC array 504. Array 530 of vertical electrodes 530A-530M is adjacent LC cavity 520 and opposite common horizontal electrode 521. Vertical electrodes 530A-530M are electrically isolated from each other by a gap, and each vertical electrode serves as the second electrode for an LC subpixel of LC array 504, similar to transparent electrode 407 in FIG. 4. Thus, each LC subpixel 504A-504M is defined by a region of LC cavity 520 located between common horizontal electrode 521 and one of the vertical electrodes of array 530, and can be independently controlled based on the voltage applied to the appropriate vertical electrode. For example, LC macropixel 504A is the shaded region in FIG. 5B corresponding to the portion of LC cavity 520 that is between common horizontal electrode 521 and vertical electrode 530A.

As noted above in conjunction with FIG. 5A, each of LC macropixels 504A-N of LC array 504 is made up of one or more subpixels, where the number of subpixels aggregated together to operate as a single macropixel is based on the channel spacing of each wavelength channel directed onto LC array 504, i.e., wavelength channels λ1-λN. Further, each of LC macropixels 504A-N is positioned to spatially correspond to the requisite wavelength channel. Thus, the wavelength channels contained in a WDM input signal, i.e., beam 510, may be arranged in an arbitrary fashion and are not required to be distributed along a uniform wavelength grid. For example, LC macropixel 504A may include five LC subpixels while adjacent LC macropixel 504B may only include a single LC subpixel, etc.

One of skill in the art will appreciate that in lieu of the transmissive, polarization-based optical beam deflectors described above, reflective optical beam deflectors may be used as part of an optical switching device, as described herein. For example, because a MEMS micromirror array consists of a large number of individually controllable pixel elements, such an array is also contemplated as a reconfigurable array of optical beam deflectors. It is understood that embodiments of the invention are not limited to configurations of optical switching device that rely on MEMS micromirror arrays or LC arrays.

While the foregoing is directed to embodiments of the present invention, other and further embodiments of the invention may be devised without departing from the basic scope thereof, and the scope thereof is determined by the claims that follow.

What is claimed is:

1. A method for routing an optical signal, comprising:
receiving an optical signal having a plurality of bands distributed over a transmission spectrum;
directing a first band having a first width along a first optical path; and
directing a second band having a second width along a second optical path,
wherein the first width and the second width are different.

2. The method of claim 1, further comprising:
directing a third band along both the first and second optical paths.

3. The method of claim 2, further comprising:
directing a fourth band along one of the first and second optical paths.

4. The method of claim 3, wherein the fourth band has a fourth width that is different from the first width.

5. The method of claim 1, wherein the bands are directed using light-reflective elements.

6. The method of claim 1, wherein the bands are directed using light-polarizing elements.

7. A method for routing an optical signal, comprising:
receiving an optical signal having a plurality of bands of different bandwidths distributed over a transmission spectrum; and
directing a group of said bands along a selected optical path,
wherein widths of at least two bands in said group are different.

8. The method of claim 7, further comprising:
directing a different group of said bands along a different optical path.

9. The method of claim 8, wherein numbers of bands in the two groups are different.

10. The method of claim 8, wherein widths of at least two bands in said different group are different.

11. The method of claim 8, wherein some of the bands in the two groups are directed along both the selected optical path and the different optical path.

12. The method of claim 8, wherein widths of at least two bands in said group are the same.

13. An optical device comprising:
an input port for receiving an optical signal having a plurality of bands of different widths distributed over a transmission spectrum; and
a switch assembly configured to direct a first group of bands along a first optical path and a second group of bands along a second optical path.

14. The optical device of claim 13, wherein the switch assembly includes an optical element for optically coupling a first band to a first pixel in an array of optical beam deflectors and a second band to a second pixel in the array of optical beam deflectors, wherein the first pixel is configured with a number of subpixels proportional to a bandwidth of the first band and the second pixel is configured with a number of subpixels proportional to a bandwidth of the second band.

15. The optical device of claim 14, further comprising:
a diffracting element for spatially separating the optical signal into its wavelength components, wherein the first band comprises a first set of wavelength components and the second band comprises a second set of wavelength components that is different from the first set.

16. The optical device of claim 14, wherein the subpixels comprise light-reflective elements.

17. The optical device of claim 14, wherein the subpixels comprise light-polarizing elements.

18. The optical device of claim 13, wherein the switch assembly includes an optical element for optically coupling the first group of bands to a first pixel in an array of optical beam deflectors and the second group of bands to a second pixel in the array of optical beam deflectors, wherein the first pixel is configured with a number of subpixels proportional to a bandwidth of the first group of bands and the second pixel is configured with a number of subpixels proportional to a bandwidth of the second group of bands.

19. The optical device of claim 13, wherein numbers of bands in the first and second groups are different.

20. The optical device of claim 19, wherein the bands in said one of the first and second groups of bands have different bandwidths.
